(19) United States
(12) Patent Application Publication
(10) Pub. No.: US 2015/0363518 A1
(43) Pub. Date: Dec. 17, 2015

(54) DYNAMIC OPERATING PROCEDURES FOR EMERGENCY RESPONSE

(71) Applicant: International Business Machines Corporation, Armonk, NY (US)

(72) Inventors: Jeff L. Edgington, Keller, TX (US); Hung Tack Kwan, Grand Prairie, TX (US); Shiju Mathai, Carrollton, TX (US)

(21) Appl. No.: 14/302,068

(22) Filed: Jun. 11, 2014

(51) Int. Cl. G06F 17/50

(52) U.S. Cl. CPC G06F 17/5009

(57) ABSTRACT

An occurrence of an emergency event can be detected. Parameters corresponding to performance of a first plurality of tasks performed in accordance with an existing operating procedure in response to the emergency event can be monitored. Based on the parameters a first performance rank for the existing operating procedure can be determined. A dynamic operating procedure comprising a second plurality of tasks can be generated, the dynamic operating procedure configured to define a response to the emergency event. Performance of each of the second plurality of tasks contained in the dynamic operating procedure can be simulated and, based on the simulation, a second performance rank for the first dynamic operating procedure can be determined. At least the first performance rank for the existing operating procedure, the first dynamic operating procedure, and the second performance rank for the dynamic operating procedure can be output.

### BACKGROUND

Arrangements described herein relate to standard operating procedures implemented by emergency response agencies.

Throughout the world, numerous emergency response agencies have been created to address various crises and natural disasters that inevitably occur. These agencies typically are tasked with preparing for, and responding to, such emergencies, and are expected to do so in an effective and efficient manner. To that end, emergency response agencies typically implement standard operating procedures (SOPs) as an integral part of crisis management and planning SOPs often define triggers and activation sequences that launch implementation of the SOPs when an emergency event occurs, describe procedures to be followed when an emergency event occurs, and describe roles of various personnel in crisis management.

### SUMMARY

A method includes detecting, in real time, an occurrence of an emergency event and automatically monitoring, in real time, parameters corresponding to performance of a first plurality of tasks performed in accordance with an existing operating procedure in response to the emergency event. The method also includes, based on the parameters corresponding to the performance of the first plurality of tasks, determining a first performance rank for the existing operating procedure indicating a level of performance of the existing operating procedure at achieving a desired result. The method further includes automatically generating, using a processor, a first dynamic operating procedure comprising a second plurality of tasks, the first dynamic operating procedure configured to define a response to the emergency event. The method also includes simulating, in real time, performance of each of the second plurality of tasks contained in the first dynamic operating procedure and, based on simulating the performance of each of the second plurality of tasks, determining a second performance rank indicating a level of performance of the first dynamic operating procedure at achieving the desired result. Further, the method includes outputting at least the first performance rank for the existing operating procedure indicating the level of performance of the existing operating procedure at achieving a desired result, the first dynamic operating procedure, and the second performance rank indicating the level of performance of the first dynamic operating procedure at achieving the desired result.

A system includes a processor programmed to initiate executable operations. The executable operations include detecting, in real time, an occurrence of an emergency event and automatically monitoring, in real time, parameters corresponding to performance of a first plurality of tasks performed in accordance with an existing operating procedure in response to the emergency event. The executable operations also include, based on the parameters corresponding to the performance of the first plurality of tasks, determining a first performance rank for the existing operating procedure indicating a level of performance of the existing operating procedure at achieving a desired result. The executable operations further include automatically generating a first dynamic operating procedure comprising a second plurality of tasks, the first dynamic operating procedure configured to define a response to the emergency event. The executable operations also include simulating, in real time, performance of each of the second plurality of tasks contained in the first dynamic operating procedure and, based on simulating the performance of each of the second plurality of tasks, determining a second performance rank indicating a level of performance of the first dynamic operating procedure at achieving the desired result. Further, the executable operations include outputting at least the first performance rank for the existing operating procedure indicating the level of performance of the existing operating procedure at achieving a desired result, the first dynamic operating procedure, and the second performance rank indicating the level of performance of the first dynamic operating procedure at achieving the desired result.

A computer program includes a computer readable storage medium having program code stored thereon. The program code is executable by a processor to perform a method. The method includes detecting, by the processor, in real time, an occurrence of an emergency event and automatically monitoring, by the processor, in real time, parameters corresponding to performance of a first plurality of tasks performed in accordance with an existing operating procedure in response to the emergency event. The method also includes, based on the parameters corresponding to the performance of the first plurality of tasks, determining, by the processor, a first performance rank for the existing operating procedure indicating a level of performance of the existing operating procedure at achieving a desired result. The method further includes automatically generating, by the processor, a first dynamic operating procedure comprising a second plurality of tasks, the first dynamic operating procedure configured to define a response to the emergency event. The method also includes simulating, by the processor, in real time, performance of each of the second plurality of tasks contained in the first dynamic operating procedure and, based on simulating the performance of each of the second plurality of tasks, determining, by the processor, a second performance rank indicating a level of performance of the first dynamic operating procedure at achieving the desired result. Further, the method includes outputting, by the processor, at least the first performance rank for the existing operating procedure indicating the level of performance of the existing operating procedure at achieving a desired result, the first dynamic operating procedure, and the second performance rank indicating the level of performance of the first dynamic operating procedure at achieving the desired result.

### BRIEF DESCRIPTION OF THE SEVERAL VIEWS OF THE DRAWINGS

FIG. 1 is a block diagram illustrating an example of a dynamic operating procedure system.

FIG. 2 is a block diagram illustrating example architecture for a data processing system.

FIG. 3 is a flow chart illustrating an example of a method of generating dynamic operating procedures.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to generating dynamic operating procedures and, more particularly, to generating dynamic operating procedures that improve on existing operating procedures, such as existing standard operating procedures (SOPs). In accordance with the inventive arrangements disclosed herein, occurrence of emergency events can be detected in real time as an emergency or crisis unfolds. One or more emergency response agencies may respond to the emergency events, typically by performing a number of tasks predefined in their existing operating procedures.

As the tasks are performed, a dynamic operating procedure system (system) can monitor, in real time, parameters corresponding to the performance of the tasks. The system also can monitor parameters corresponding to an environment in which each of the tasks is performed. Based on the monitored parameters, the system can determine a performance rank for the tasks, a performance rank for the existing operating procedure and/or a performance rank for a set of operating procedures (e.g., SOPs) including the existing operating procedure. Each performance rank can indicate a level of performance at achieving a desired result. For example, the system can simulate, in real time as each task is completed, performance of the tasks performed. The system also can simulate, in real time as each operating procedure is completed, performance of the operating procedure. Further, the system can simulate, in real time, performance of a set of operating procedures. The parameters obtained from the monitoring can be provided as input parameters for this simulation. The combined performance results of the completed tasks and operating procedures can be processed to arrive at performance ranks for the tasks, operating procedures and sets of operating procedures.

The system can automatically generate one or more sets of dynamic operating procedures configured to define responses to emergency event unfolding in the current emergency or crisis. In this regard, each set of dynamic operating procedure can be considered a potential candidate to be implemented in the current emergency or crisis. Each set of dynamic operating procedures can include a plurality of individual operating procedures, each of which include one or more tasks and define the manner in which the tasks are to be implemented. The system can simulate, in real time, performance of such tasks, performance of the individual operating procedures, and performance of the set of dynamic operating procedures to determine corresponding performance rankings. Each performance ranking can indicate a level of performance at achieving desired result.

The system can output each set of dynamic operating procedures, as well as corresponding performance rankings. The monitored data also can be output. The information can be presented to one or more users (e.g., emergency response coordinators) providing insights and recommendations to improve emergency response procedures. Notably, the sets of dynamic operating procedures can be generated and data can be output in real time as an emergency or crisis unfolds. Accordingly, the dynamic operating procedures can aid users in making critical decisions quickly, based on objective data, thus improving the performance of agency response to the current emergency or crisis. For example, users of the system can quickly determine whether to implement the dynamically generated operating procedures based, at least in part, on the performance rankings. This can be particularly useful when unexpected events arise and new resources are required to provide an appropriate response. Further, users can use the dynamic operating procedures, or aspects of the dynamic operating procedures, to revise and improve their current standard operating procedures, thus improving the performance of responses to future emergencies or crises.

Several definitions that apply throughout this document now will be presented.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), an application specific integrated circuit (ASIC) and a controller.

As defined herein, the term “emergency event” means an event that occurs during an emergency or crisis.

As defined herein, the term “operating procedure” means a procedure including one or more tasks to be performed in response to at least one emergency event.

As defined herein, the term “existing operating procedure” means an operating procedure that exists prior to the occurrence of a current emergency or crisis.

As defined herein, the term “dynamically generated operating procedure” means an operating procedure dynamically generated to include one or more tasks selected and/or defined to address one or more emergency events of an emergency or crisis.

As defined herein, the term “standard operating procedures” means compiled a set of existing operating procedures. Standard operating procedures may be established by a particular organization (e.g., emergency response agency) to define groups of tasks to be executed in response to various emergency events.

As defined herein, the term “dynamic operating procedures” means a dynamically generated set of operating procedures, wherein the dynamically generated set of operating procedures does not precisely correspond to a set of operating procedures compiled in standard operating procedures. The set of one or more operating procedures in the dynamic operating procedures can include one or more operating procedures that are dynamically generated, one or more operating procedures that are dynamically generated in combination with one or more existing operating procedures, or one or more existing operating procedures combined in a manner not previously combined in standard operating procedures.

As defined herein, the term “known operating procedures” means a set of operating procedures known to a system. Known operating procedures can include standard operating procedures and previously generated dynamic operating procedures. For example, when generating or compiling a new set of dynamic operating procedures, a set of dynamic operating procedures generated or compiled before the new set of dynamic operating procedures are known operating procedures.

As defined herein, the term “environment” means one or more conditions relevant to a response to an emergency event. Such a condition can include, for example, a geographic location of an emergency event, a location of an emergency event within a structure, a traffic condition, a weather condition, a structural condition, availability of resources, a number of casualties, a number of people injured, types of injuries, social conditions (e.g., crowds, crime rates, rioting, etc.), hazardous conditions (e.g., presence of fire, hazardous chemicals, explosives, etc.), or any other conditions that may have relevance as to how a response to an emergency event is, or should be, handled, or that may impact response to an emergency event.

As defined herein, the term “performance rank” means a value assigned to an existing operating procedure, a dynamic operating procedure or a dynamic operating procedure indicating the effectiveness and/or efficiency of such at achieving a desired result.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

As defined herein, the term “user” means a person (i.e., a human being).

As used herein, the term “output” means storing in memory elements, for example, writing to a file stored in the memory elements, writing to display or other peripheral output device, playing audible notifications, sending or transmitting to another system, exporting, or the like.

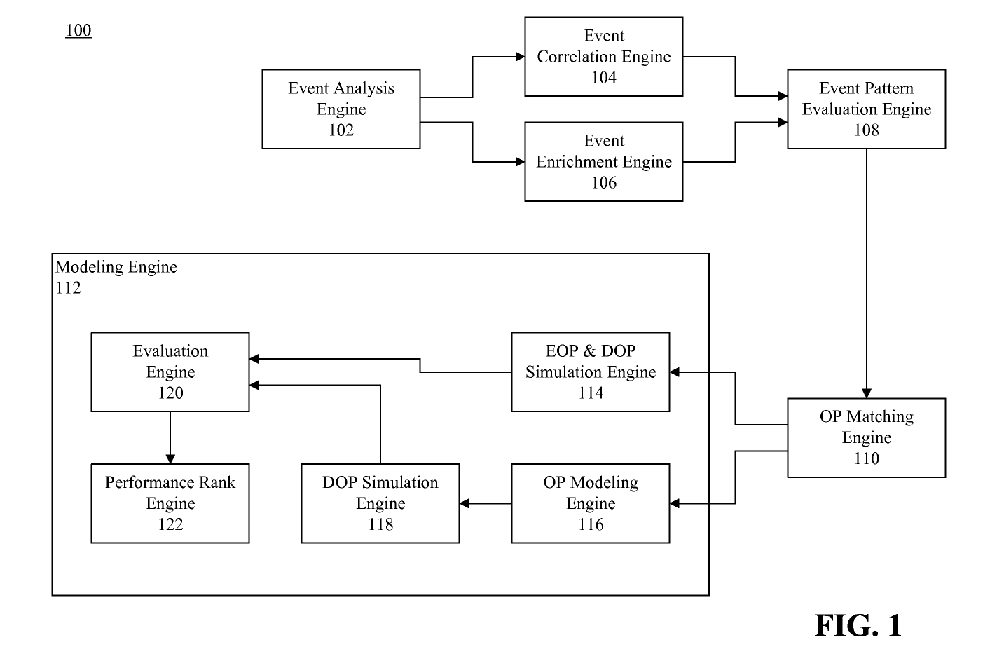

FIG. 1 is a block diagram illustrating an example of a dynamic operating procedure system (system) 100. The system 100 can include an event analysis engine 102 configured to monitor and collect data related to an emergency or crisis from external systems as an emergency or crisis unfolds. For example, the event analysis engine 102 can monitor communications to, from, within and among emergency response agencies to detect, in real time, occurrences of emergency events. For example, the event analysis engine 102 can detect and analyze calls into 911 and 311 call systems, dispatch communications, responder communications, and the like. The event analysis engine 102 also can analyze information received and generated by computer aided dispatch systems. Further, the event analysis engine 102 can monitor and collect other data pertaining to emergency events, such as information relating to tasks that are implemented in response to the emergency events, parameters corresponding to the performance of the tasks, parameters corresponding to the environment relevant to the emergency events and/or the environment in which the tasks are performed, etc. The event analysis engine 102 also can monitor and collect data from radio and/or television broadcasts related to emergency events, social media data related to emergency events (e.g., posts on social media websites), and the like.

The event analysis engine 102 can monitor and collect data via any suitable communication networks. Such communication networks may include connections, such as wire, wireless communication links, or fiber optic cables. The communication networks may include, for example, emergency dispatch systems, systems used by emergency responders to communicate among one another, broadcast communication systems (e.g., radio and/or television broadcast systems), and the like. The communication networks also can be implemented as, or include, any of a variety of different communication technologies such as a wide area network (WAN), a local area network (LAN), a wireless network, a mobile network, a Virtual Private Network (VPN), the Internet, the Public Switched Telephone Network (PSTN), or the like.

As the data is collected, the event analysis engine 102 can, in addition to storing the data, also analyze the data in real time along with data previously collected. Notably, the previously collected data can include not only information contained in a local emergency management system, but also information contained in other emergency management systems. Such previously collected can include data previously collected for other emergency events that occur in the current emergency or crises, previously collected data associated with other emergencies or crises, and other data that may be relevant to emergency management. Based on the analysis of the data, the event analysis engine 102 can identify patterns that exist in a current emergency event, identify contextual information, and store corresponding pattern and context data. By way of example, the event analysis engine 102 can identify patterns of events occurring in a current emergency or crisis, and compare those patterns to event patterns of previous emergencies or crises. Based on the comparison, the event analysis engine 102 can identify the context of the current emergency events, and identify emergency events that need attention or further analysis.

The system 100 also can include an event correlation engine 104 and an event enrichment engine 106. The event correlation engine 104 can access the data detected/processed by the event analysis engine 102 to, in real time, identify temporal and spatial information related to emergency events (e.g., what happened, when did it happen and where did it happen), identify categories and/or levels of severity of emergency events, and the like. Further, the event correlation engine 104 can determine whether different emergency events that are detected by the event analysis engine 102 correlate to the same emergency or crisis. For example, if the event analysis engine 102 detects a call to a 311 call system reporting the smell of gas and also detects a call to a 911 system reporting an explosion in the same general vicinity soon after the report of the smell of gas, the event correlation engine 104 can identify the smell of gas and the explosion as events corresponding to the same emergency. The event correlation engine 104 can generate event correlation information to augment the event data output by the event analysis engine 102 and output the augmented data.

The event enrichment engine 106 can access the data detected/processed by the event analysis engine 102 and, in real time, enrich such data with additional data. For example, the event enrichment engine 106 can correlate parameters related to environments in which emergency events occur to the emergency events and tasks performed in response to the emergency events. In illustration, the event enrichment engine 106 can correlate information such as a time of day, a weather condition, information about a particular geographic location, injuries reported, nearby structures, age of a building, etc. The event enrichment engine 106 also can correlate to the data information relating to the availability of resources and/or personnel, organizational structures within emergency response agencies, relationships among various emergency response agencies, responsibilities assigned to various emergency response agencies and personnel, and the like. The event enrichment engine 106 can generate event enrichment information to augment the event data output by the event analysis engine 102 and output the augmented data.

The system 100 also can include an event pattern evaluation engine 108 configured to process the augmented data output by the event correlation engine 104 and the event enrichment engine 106. More particularly, the event pattern evaluation engine 108 can compare information gathered and generated for current emergency events to previous emergency events to determine whether the current event pattern matches event patterns of previous emergency events. As noted, such previous emergency events can be events that may have occurred anywhere in the world. Based on the current emergency events and previous event patterns, the event pattern evaluation engine 108 can derive an event pattern for the current emergency events. This event pattern can be updated and/or revised in real time as new emergency event information is gathered by the event analysis engine 102.

The event pattern evaluation engine 108 also can analyze response patterns for previous emergency events that correlate with the current emergency events. In this regard, the event pattern evaluation engine 108 can access rankings (e.g., scores) assigned to previously defined tasks indicating a level of performance (e.g., effectiveness, efficiency, etc.) of such tasks at responding to particular emergency events. Based on the analysis, the event pattern evaluation engine 108 can categorize the current emergency events and assign risk values to them, evaluate performance of previous responses to similar emergency events, and evaluate the likely performance of such previous responses to the current emergency events. In one aspect, the event pattern evaluation engine 108 also can evaluate the performance of generated dynamic operating procedures to the current emergency events. Further, the pattern evaluation engine 108 can identify the characteristics associated with the current emergency events and attempt to locate and evaluate any historical events and their respective responses (e.g., operating procedures and tasks) where the engine finds some similarity in characteristics. These characteristics can include (but are not limited to) event type (e.g. flooding, wild fire, earthquake), current weather conditions and forecasted conditions, location, population, etc.

The event pattern evaluation engine 108 also can evaluate, in real time, seemingly different events, or sets of events, to determine whether there is any correlation between the different events. For example, assume the event pattern evaluation engine 108 identifies a fire/building collapse event, a bomb threat and a traffic accident each occurring in a central business district around the same time a high priority event is scheduled in the central business district. The event pattern evaluation engine 108 can identify an event pattern that indicates these seemingly unrelated events are indeed related. For example, the fire/building collapse event, bomb threat and traffic accident can be possible diversions to pull resources away from the high priority event.

The system 100 also can include an operating procedure (OP) matching engine 110 configured to select, from known operating procedures, operating procedures potentially suitable for implementation in response to the event pattern for the current emergency events derived by the event pattern evaluation engine 108. The known operating procedures can be pre-defined standard operating procedures or previously generated dynamic operating procedures. The OP matching engine 110 can output, to a modeling engine 112, a listing of known operating procedures potentially relevant to addressing the current emergency events, as well as any rankings of the known operating procedures. Further, the OP matching engine 110 can select known tasks potentially are relevant to current emergency events, and output a listing of such tasks to the modeling engine 112. When performing the selection of operating procedures, the OP matching engine 110 can identify deviations where the procedural characteristics for the current emergency events, generated by the event pattern evaluation engine 108, are not met adequately by any known operating procedures. The OP matching engine 110 also can identify when known operating procedures have been ranked (e.g., scored) as underperforming for any of the current procedural needs. Such identifications also can be provided to the modeling engine 112.

The modeling engine 112 can include an existing operating procedure and dynamic operating procedure (EOP & DOP) evaluation engine 114. The EOP & DOP evaluation engine 114 can receive the information generated by the OP matching engine 110 and, in real time, evaluate current and relevant past emergency event patterns, in the context of a current emergency or crisis (e.g., including environment information, etc.), against known operating procedures selected by the OP matching engine 110. As noted, the known operating procedures can include operating procedures defined in existing operating procedures and/or previously generated dynamic operating procedures, including operating procedures currently being implemented. The EOP & DOP evaluation engine 114 can, based on the analysis, generate at least one set of new dynamic operating procedures using operating procedures defined in the known operating procedures based on the evaluated emergency event patterns. In other words, the EOP & DOP evaluation engine 114 can generate a new set of new dynamic operating procedures, in real time, by selecting individual operating procedures defined in existing standard operating procedures and/or dynamic operating procedures to combine the selected operating procedures in a different order of implementation. Such operating procedure selection can be based, at least in part, on the derived emergency event patterns.

The EOP & DOP evaluation engine 114 also can perform real time simulations in which the known sets of operating procedures and the new set of dynamic operating procedures are applied to composed models of emergency events and event patterns, which may include composed models of emergency of events and event patterns which have occurred in the current emergency or crisis. Based on these simulations, a ranking (e.g., score) can be generated for each of the operating procedures indicating the simulated performance of each at achieving a desired result. Further, based on the simulations, a ranking can be generated for each set of operating procedures.

The modeling engine 112 also can include an operating procedure (OP) modeling engine 116 and a dynamic operating procedure (DOP) simulation engine 118. The OP modeling engine 116 can, in real time, compose individual dynamic operating procedures, in contrast to the EOP & DOP evaluation engine 114 which compiles existing operating procedures into a new set of dynamic operating procedures. For example, the OP modeling engine 116 can identify event patterns corresponding to an emergency event, derived by the event pattern evaluation engine 108, which are not suitably addressed by known operating procedures. The OP modeling engine 116 can analyze such event patterns to generate new dynamic operating procedures configured to better address such event patterns by deriving the new dynamic operating procedures based, at least in part, on the derived event patterns.

For each new dynamic operating procedure, the OP modeling engine 116 can select specific tasks to include in the dynamic operating procedure. For example, based on the event pattern of a particular emergency event, the OP modeling engine 116 can compile one or more tasks into a dynamic operating procedure configured to define an appropriate response to the emergency event. The OP modeling engine 116 can use tasks previously defined in known operating procedures or other defined tasks. For example, the OP modeling engine 116 can access a data table including a plurality of tasks, and select tasks from that table that may be appropriate to responding to the emergency event. In one arrangement, the OP modeling engine 116 also can generate new tasks to be included in dynamic operating procedures. For example, based on the context of an emergency event, the OP modeling engine 116 can apply algorithms that process information corresponding to an emergency event to derive one or more new tasks that may be suitable for implementation in response to the emergency event.

The DOP simulation engine 118 can combine one or more dynamic operating procedures generated by the OP modeling engine 116 with one or more known operating procedures to create a new set of dynamically generated operating procedures. Further, the DOP simulation engine 118 can perform real time simulations in which the new set of dynamic operating procedures are applied to the composed models of emergency events. Based on these simulations, a ranking can be generated for each new dynamic operating procedure indicating the simulated performance of each at achieving a desired result. Further, based on the simulations, a ranking can be generated for the new set of dynamic operating procedures.

The modeling engine further can include an evaluation engine 120. The evaluation engine 120 can receive sets of operating procedures, including known operating procedures and newly generated dynamic operating procedures, as well as their rankings, from the EOP & DOP evaluation engine 114 and the DOP simulation engine 118. The evaluation engine 120 can perform further simulations to evaluate the performance of each set of operating procedures at responding to event patterns of an emergency or crisis as a whole. Notably, this performance evaluation can be performed down to the task level of each of the operating procedures, and rankings of individual tasks and/or operating procedures can be combined to generate a total score for each set of operating procedures.

The modeling engine further can include a performance rank engine 122. The performance rank engine 122 can obtain data generated by the evaluation engine 120 and apply a scoring algorithm to each set of operating procedures, including sets of existing operating procedures, previously generated dynamic operating procedures, and newly generated dynamic operating procedures. The scoring for each set of operating procedures can be based on a set of criteria to which the operating procedures, including its rankings, is compared. These scores can be performance ranks indicating the overall performance of each set of operating procedures, performance ranks indicating the performance each operating procedure contained in the set, and performance ranks indicating the performance each task defined in each operating procedure. The scoring algorithm can be defined, for example, by an emergency response agency (e.g., an emergency response center).

The performance rank engine 122 can select from the various sets of operating procedures evaluated those sets which have a performance rank meeting a particular threshold value (e.g., a score criteria). Moreover, the performance rank engine 122 can output the sets of operating procedures and their performance ranks in a hierarchical order according to their respective scores. In the case that standard operating procedures exist, the performance rank of such operating procedures also can be output, even if they do not meet the particular threshold value, for comparison purposes. In one aspect, the standard operating procedures also can be output to facilitate comparison to generated dynamic operating procedures.

Users, such as emergency response coordinators, can review such output to easily compare the effectiveness of different sets of operating procedures, down to the task level if so desired, and choose operating procedures to implement. In illustration, during an emergency or crisis, a user can review the output of the performance rank engine 122 and, if a newly generated set of dynamic operating procedures has a suitable score in comparison to known sets of operating procedures, select the newly generated set of dynamic operating procedures to be immediately implemented to improve emergency response in the current emergency or crisis. For example, the newly generated set of dynamic operating procedures can be added to an operating procedure database accessed by emergency responders.

Notably, the aforementioned processes can be continually performed in real time. As each new set of dynamic operating procedures are generated and analyzed, new sets of dynamic operating procedures can be generated and analyzed. These new dynamic operating procedures and their performance ranks can be output. Accordingly, as event patterns evolve in a current emergency or crisis, the generation of dynamic operating procedures can evolve to better address the emergency or crisis as it unfolds. Moreover, emergency response coordinators can very quickly implement new response strategies to improve emergency response performance based on the information presented to the coordinators by the system 100.

Further, information output by the system 100 can be utilized to improve existing standard operating procedures to better prepare for further emergency events or crises. By way of example, after an emergency or crisis subsides, the system 100 can be utilized to evaluate the performance of the dynamic operating procedures at addressing the emergency events. If implementation of the dynamic operating procedures showed improved performance over existing operating procedures, emergency response coordinators can revise their current standard operating procedures to implement the dynamic operating procedures, or certain aspects of the dynamic operating procedures.

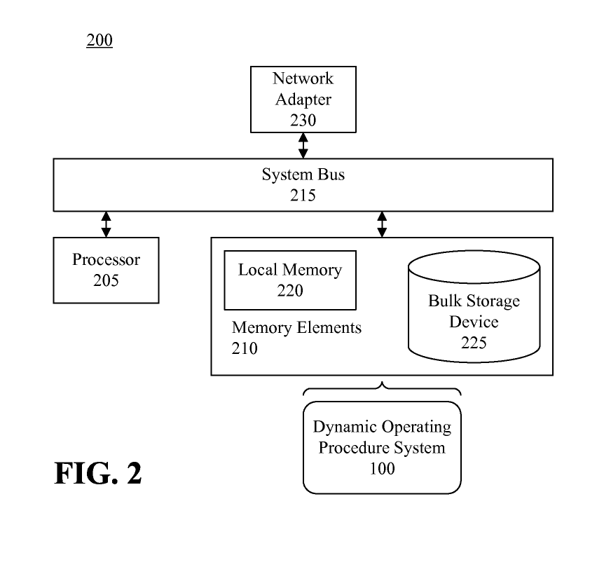

FIG. 2 is a block diagram illustrating example architecture for a data processing system 200 configured to execute the dynamic operating procedure system 100 of FIG. 1.

The data processing system 200 can include at least one processor 205 (e.g., a central processing unit) coupled to memory elements 210 through a system bus 215 or other suitable circuitry. As such, the data processing system 200 can store program code within the memory elements 210. The processor 205 can execute the program code accessed from the memory elements 210 via the system bus 215. It should be appreciated that the data processing system 200 can be implemented in the form of any system including a processor and memory that is capable of performing the functions and/or operations described within this specification. For example, the data processing system 200 can be implemented as a computer, a workstation, a mobile computer, a laptop computer, a tablet computer, a smart phone, a personal digital assistant, a gaming device, an appliance, and so on.

The memory elements 210 can include one or more physical memory devices such as, for example, local memory 220 and one or more bulk storage devices 225. Local memory 220 refers to random access memory (RAM) or other non-persistent memory device(s) generally used during actual execution of the program code. The bulk storage device(s) 225 can be implemented as a hard disk drive (HDD), solid state drive (SSD), or other persistent data storage device. The data processing system 200 also can include one or more cache memories (not shown) that provide temporary storage of at least some program code in order to reduce the number of times program code must be retrieved from the bulk storage device 225 during execution.

One or more network adapters 230 can be coupled to data processing system 200 to enable data processing system 200 to become coupled to other systems, computer systems, remote printers, and/or remote storage devices through intervening private or public networks. Modems, cable modems, transceivers, and Ethernet cards are examples of different types of network adapters 230 that can be used with the data processing system 200.

As pictured in FIG. 2, the memory elements 210 can store the dynamic operating procedure system 100 of FIG. 1. Being implemented in the form of executable program code, the dynamic operating procedure system 100 can be executed by the data processing system 200 and, as such, can be considered part of the data processing system 200. Moreover, the various components of the dynamic operating procedure system 100, as well as data processed by the dynamic operating procedure system 100, are functional data structures that impart functionality when employed as part of the data processing system 200 of FIG. 2. The data processing system 200 can output data generated by the dynamic operating procedure system 100, for example by writing the data to a display, storing the data in the memory elements 210, or communicating the data to another system.

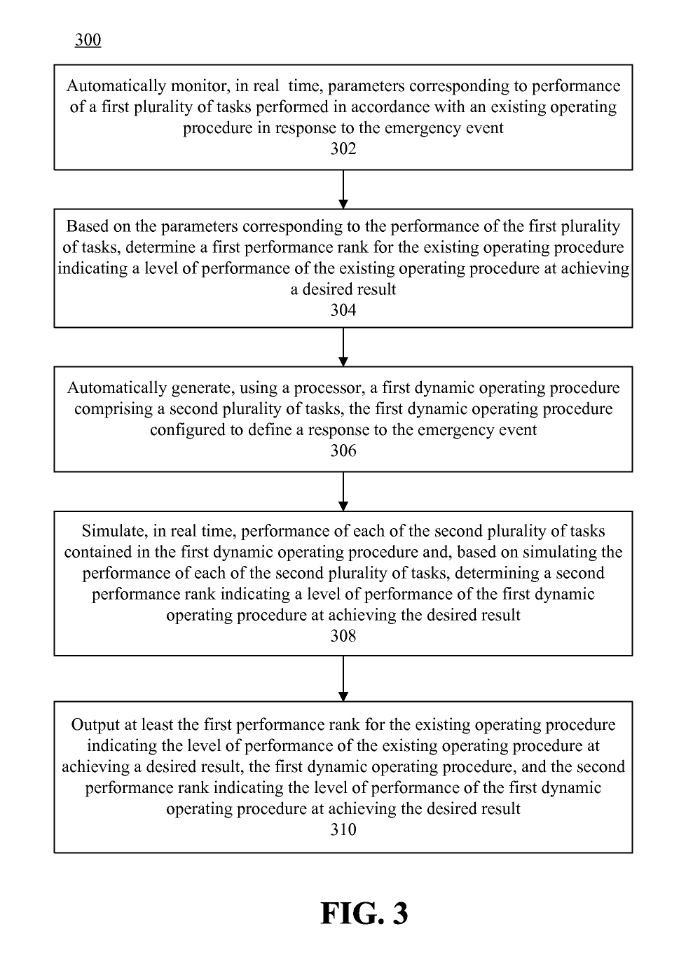

FIG. 3 is a flow chart illustrating an example of a method 300 of generating dynamic operating procedures. At step 302, parameters corresponding to performance of a first plurality of tasks performed in accordance with an existing operating procedure in response to the emergency event can be automatically monitored in real time. At step 304, based on the parameters corresponding to the performance of the first plurality of tasks, a first performance rank for the existing operating procedure can be determined. The first performance rank can indicate a level of performance of the existing operating procedure at achieving a desired result. At step 306, a first dynamic operating procedure can be automatically generated using a processor. The first dynamic operating procedure can include a second plurality of tasks and can be configured to define a response to the emergency event. At step 308, performance of each of the second plurality of tasks contained in the first dynamic operating procedure can be simulated in real time. Based on simulating the performance of each of the second plurality of tasks, a second performance rank indicating a level of performance of the first dynamic operating procedure at achieving the desired result can be determined. At step 310, at least the first performance rank for the existing operating procedure indicating the level of performance of the existing operating procedure at achieving a desired result, the first dynamic operating procedure, and the second performance rank indicating the level of performance of the first dynamic operating procedure at achieving the desired result can be output.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
detecting, in real time, an occurrence of an emergency event;
automatically monitoring, in real time, parameters corresponding to performance of a first plurality of tasks performed in accordance with an existing operating procedure in response to the emergency event;
based on the parameters corresponding to the performance of the first plurality of tasks, determining a first performance rank for the existing operating procedure indicating a level of performance of the existing operating procedure at achieving a desired result;
automatically generating, using a processor, a first dynamic operating procedure comprising a second plurality of tasks, the first dynamic operating procedure configured to define a response to the emergency event;
simulating, in real time, performance of each of the second plurality of tasks contained in the first dynamic operating procedure and, based on simulating the performance of each of the second plurality of tasks, determining a second performance rank indicating a level of performance of the first dynamic operating procedure at achieving the desired result; and
outputting at least the first performance rank for the existing operating procedure indicating the level of performance of the existing operating procedure at achieving a desired result, the first dynamic operating procedure, and the second performance rank indicating the level of performance of the first dynamic operating procedure at achieving the desired result.

2. The method of claim 1, wherein determining the first performance rank for the existing operating procedure indicating the level of performance of the existing operating procedure at achieving the desired result comprises:
simulating, in real time, performance of each of the first plurality of tasks contained in the existing operating procedure and, based on simulating the performance of each of the first plurality of tasks, determining the first performance rank indicating the level of performance of the existing operating procedure at achieving the desired result.

3. The method of claim 2, wherein:
simulating, in real time, performance of each of the first plurality of tasks contained in the existing operating procedure comprises processing parameters corresponding to an environment in which the first plurality of tasks are performed as simulation input parameters; and
simulating, in real time, performance of each of the second plurality of tasks contained in the first dynamic operating procedure comprises processing the parameters corresponding to the environment in which the first plurality of tasks are performed as simulation input parameters.

4. The method of claim 1, further comprising:
deriving an event pattern for the emergency event;
wherein automatically generating the first dynamic operating procedure comprises deriving the first dynamic operating procedure based on the event pattern derived for the emergency event.

5. The method of claim 1, further comprising:
automatically generating, using the processor, a second dynamic operating procedure comprising a third plurality of tasks, the second dynamic operating procedure configured to define the response to the emergency event;
simulating, in real time, performance of each of the third plurality of tasks contained in the second dynamic operating procedure and, based on simulating the performance of each of the third plurality of tasks, determining a third performance rank indicating a level of performance of the second dynamic operating procedure at achieving the desired result; and
outputting the second dynamic operating procedure and the third performance rank indicating the level of performance of the second dynamic operating procedure at achieving the desired result.

6. The method of claim 1, further comprising:
automatically generating a set of dynamic operating procedures, the set of dynamic operating procedures including the first dynamic operating procedure and at least one other operating procedure;
simulating, in real time, performance of the other operating procedure; and
based at least on simulating the performance of the other operating procedure and the second performance rank, determining a third performance rank indicating a level of performance of the set of dynamic operating procedures; and
outputting the set of dynamic operating procedures and the third performance rank.

7. The method of claim 1, wherein outputting the first dynamic operating procedure and the second performance rank indicating the level of performance of the first dynamic operating procedure at achieving the desired result is responsive to the performance rank meeting a threshold value.

8. A system, comprising:
a processor programmed to initiate executable operations comprising:
detecting, in real time, an occurrence of an emergency event;
automatically monitoring, in real time, parameters corresponding to performance of a first plurality of tasks performed in accordance with an existing operating procedure in response to the emergency event;
based on the parameters corresponding to the performance of the first plurality of tasks, determining a first performance rank for the existing operating procedure indicating a level of performance of the existing operating procedure at achieving a desired result;
automatically generating a first dynamic operating procedure comprising a second plurality of tasks, the first dynamic operating procedure configured to define a response to the emergency event;
simulating, in real time, performance of each of the second plurality of tasks contained in the first dynamic operating procedure and, based on simulating the performance of each of the second plurality of tasks, determining a second performance rank indicating a level of performance of the first dynamic operating procedure at achieving the desired result; and
outputting at least the first performance rank for the existing operating procedure indicating the level of performance of the existing operating procedure at achieving a desired result, the first dynamic operating procedure, and the second performance rank indicating the level of performance of the first dynamic operating procedure at achieving the desired result.

9. The system of claim 8, wherein determining the first performance rank for the existing operating procedure indicating the level of performance of the existing operating procedure at achieving the desired result comprises:
simulating, in real time, performance of each of the first plurality of tasks contained in the existing operating procedure and, based on simulating the performance of each of the first plurality of tasks, determining the first performance rank indicating the level of performance of the existing operating procedure at achieving the desired result.

10. The system of claim 9, wherein:
simulating, in real time, performance of each of the first plurality of tasks contained in the existing operating procedure comprises processing parameters corresponding to an environment in which the first plurality of tasks are performed as simulation input parameters; and
simulating, in real time, performance of each of the second plurality of tasks contained in the first dynamic operating procedure comprises processing the parameters corresponding to the environment in which the first plurality of tasks are performed as simulation input parameters.

11. The system of claim 8, the executable operations further comprising:
deriving an event pattern for the emergency event;
wherein automatically generating the first dynamic operating procedure comprises deriving the first dynamic operating procedure based on the event pattern derived for the emergency event.

12. The system of claim 8, the executable operations further comprising:
automatically generating, using the processor, a second dynamic operating procedure comprising a third plurality of tasks, the second dynamic operating procedure configured to define the response to the emergency event;
simulating, in real time, performance of each of the third plurality of tasks contained in the second dynamic operating procedure and, based on simulating the performance of each of the third plurality of tasks, determining a third performance rank indicating a level of performance of the second dynamic operating procedure at achieving the desired result; and
outputting the second dynamic operating procedure and the third performance rank indicating the level of performance of the second dynamic operating procedure at achieving the desired result.

13. The system of claim 8, the executable operations further comprising:
automatically generating a set of dynamic operating procedures, the set of dynamic operating procedures including the first dynamic operating procedure and at least one other operating procedure;
simulating, in real time, performance of the other operating procedure; and
based at least on simulating the performance of the other operating procedure and the second performance rank, determining a third performance rank indicating a level of performance of the set of dynamic operating procedures; and
outputting the set of dynamic operating procedures and the third performance rank.

14. The system of claim 8, wherein outputting the first dynamic operating procedure and the second performance rank indicating the level of performance of the first dynamic operating procedure at achieving the desired result is responsive to the performance rank meeting a threshold value.

15. A computer program product comprising a computer readable storage medium having program code stored thereon, the program code executable by a processor to perform a method comprising:
detecting, by the processor, in real time, an occurrence of an emergency event;
automatically monitoring, by the processor, in real time, parameters corresponding to performance of a first plurality of tasks performed in accordance with an existing operating procedure in response to the emergency event;
based on the parameters corresponding to the performance of the first plurality of tasks, determining, by the processor, a first performance rank for the existing operating procedure indicating a level of performance of the existing operating procedure at achieving a desired result;
automatically generating, by the processor, a first dynamic operating procedure comprising a second plurality of tasks, the first dynamic operating procedure configured to define a response to the emergency event;
simulating, by the processor, in real time, performance of each of the second plurality of tasks contained in the first dynamic operating procedure and, based on simulating the performance of each of the second plurality of tasks, determining a second performance rank indicating a level of performance of the first dynamic operating procedure at achieving the desired result; and
outputting, by the processor, at least the first performance rank for the existing operating procedure indicating the level of performance of the existing operating procedure at achieving a desired result, the first dynamic operating procedure, and the second performance rank indicating the level of performance of the first dynamic operating procedure at achieving the desired result.

16. The computer program product of claim 15, wherein determining, by the processor, the first performance rank for the existing operating procedure indicating the level of performance of the existing operating procedure at achieving the desired result comprises:
simulating, by the processor, in real time, performance of each of the first plurality of tasks contained in the existing operating procedure and, based on simulating the performance of each of the first plurality of tasks, determining the first performance rank indicating the level of performance of the existing operating procedure at achieving the desired result.

17. The computer program product of claim 16, wherein:
simulating, by the processor, in real time, performance of each of the first plurality of tasks contained in the existing operating procedure comprises processing parameters corresponding to an environment in which the first plurality of tasks are performed as simulation input parameters; and
simulating, by the processor, in real time, performance of each of the second plurality of tasks contained in the first dynamic operating procedure comprises processing the parameters corresponding to the environment in which the first plurality of tasks are performed as simulation input parameters.

18. The computer program product of claim 15, the method further comprising:
deriving, by the processor, an event pattern for the emergency event;
wherein automatically generating, by the processor, the first dynamic operating procedure comprises deriving the first dynamic operating procedure based on the event pattern derived for the emergency event.

19. The computer program product of claim 15, the method further comprising:
automatically generating, by the processor, a second dynamic operating procedure comprising a third plurality of tasks, the second dynamic operating procedure configured to define the response to the emergency event;
simulating, by the processor, in real time, performance of each of the third plurality of tasks contained in the second dynamic operating procedure and, based on simulating the performance of each of the third plurality of tasks, determining a third performance rank indicating a level of performance of the second dynamic operating procedure at achieving the desired result; and
outputting, by the processor, the second dynamic operating procedure and the third performance rank indicating the level of performance of the second dynamic operating procedure at achieving the desired result.

20. The computer program product of claim 15, the method further comprising:
automatically generating, by the processor, a set of dynamic operating procedures, the set of dynamic operating procedures including the first dynamic operating procedure and at least one other operating procedure;
simulating, by the processor, in real time, performance of the other operating procedure; and
based at least on simulating the performance of the other operating procedure and the second performance rank, determining, by the processor, a third performance rank indicating a level of performance of the set of dynamic operating procedures; and
outputting, by the processor, the set of dynamic operating procedures and the third performance rank.
